(19) United States
(12) Patent Application Publication
(10) Pub. No.: US 2014/0274152 A1
(43) Pub. Date: Sep. 18, 2014

(54) System and Method for Tracking of Mobile Resources

(71) Applicant: Tim Lichti, Washington, DC (US)

(72) Inventor: Tim Lichti, Washington, DC (US)

(21) Appl. No.: 14/208,035

(22) Filed: Mar. 13, 2014

Related U.S. Application Data
(60) Provisional application No. 61/782,497, filed on Mar. 14, 2013.

(51) Int. Cl. H04W 4/02; H04W 24/08

(52) U.S. Cl. CPC H04W 4/028; H04W 24/08
USPC 455/456.3

(57) ABSTRACT

A system and method for tracking items or people that displays the tracking data in a graphical display. The system receives location tracking data from a tracking unit which is stored in a server or set directly to a reporting unit. The reporting unit creates a graphical display indicating how long a user has been at various locations through changes in the location identification icon such as increasing the size of a circle depending on how much time is spent at the location. The system also can use multiple different tracking technologies to create a single monitoring session to be displayed to a user while tracking an object or person or combinations tracking units.

### RELATED APPLICATIONS

This application claims priority to U.S. Provisional Application Ser. No. 61/782,497, filed on 14 Mar.2013, which is hereby incorporated by reference in its entirety.

### FIELD OF THE INVENTION

The present invention relates to systems and methods for displaying tracking information related to an object and an indication of the amount of time the object spent at a location.

### BACKGROUND OF THE INVENTION

The current invention is a response to the present lack of a system or method for displaying location data which indicates how long an object has stayed at a specific location and the lack of integration of multiple technologies to track a single object. Current tracking techniques focus on using only one sort of tracking method. For example, a GPS tracking system only uses GPS tracking and does not generally integrate other available data streams, such as nearest known Wifi connections, to determine elevation or location within a building. These same systems, even if they do incorporate more than one tracking system, generally do not provide an easily discernable visual display that a user can look at and immediately determine where a tracked object spent a longer period of time. Most systems simply will draw a line on a map where something has been, but do not indicate how long an object has been stationary at a location.

Other problems and drawbacks also exist. A need exists for a robust solution that tracks an object and presents information regarding the amount of time the object has spent at various locations.

### SUMMARY OF THE INVENTION

An embodiment of the present invention comprises at least one location tracking device associated with an object to be tracked. The location tracking device provides location data through a network to a server. This server aggregates the location data provided to it by each location tracking device and stores the data as a monitoring session data. A reporting device receives data from the server and uses the monitoring session data to create an overlay on a map which displays where the object has been and where it has stayed for longer periods of time relative to the overall length of the monitoring sessions.

In another embodiment of the invention, the data from multiple tracking devices are combined into a single monitoring session data set from which the display is created.

Another embodiment of the location tracking device can be an active transmitter or a passive recording device that will have the location data recorded by it read from it by a reader and provided to the server or reporting device for processing.

Yet another embodiment of the invention allows for in real time updating of the display as location data is received.

### BRIEF DESCRIPTION OF THE DRAWINGS

Reference is now made to the accompanying drawings, in which:

FIGS. 1 and 2 show examples of systems suitable for tracking mobile resources in accordance with various aspects of the invention.

FIG. 3 shows a flowchart illustrating an example method for tracking mobile resources in accordance with various aspects of the invention.

FIG. 4 shows an example display view in accordance with various aspects of the invention.

FIG. 5 shows a flowchart illustrating an example method for tracking mobile resources in accordance with various aspects of the invention.

### DETAILED DESCRIPTION OF THE INVENTION

FIG. 1 shows an example system 100 suitable for tracking mobile resources. In the example shown, system 100 includes one or more tracking devices 110 associated with mobile resources. In some embodiments, tracking devices 110 can include mobile electronics such as mobile phones, pagers, mobile computers, tablet computers, cameras, vehicles, tools and the like. In some embodiments, tracking devices 110 can include RFID (radio-frequency identification) tags, GPS (global positioning system) tracking units, Automated Identification System (AIS) for ship or aircraft, wireless communication devices or other devices suitable for providing location information.

Tracking devices 110 can be associated with mobile resources such as personnel or equipment. In some examples, a tracking device 110 can be stored, mounted, carried or otherwise positioned in close proximity with the associated mobile resource. For example, a GPS tracking unit or mobile phone can be assigned to an employee or to a vehicle. Tracking devices 110 can also be basic RFID tags or GPS tracking units mounted to personnel badges, clothing, equipment or other objects generally positioned in close proximity to a mobile resource. In some examples, a tracking device itself can be the mobile resource, such as for example, a mobile phone or a vehicle with a built in GPS tracking unit.

Location information from tracking devices 110 can be communicated to one or more reporting devices 130 or servers 120 via network 101. The network 101 can include one or more public and or private networks (e.g. a private or public telecommunications network such as the internet). The network 101 can include wireless networks such as cellular telephone networks, Wi-Fi networks, satellite networks and the like. The network 101 can include RFID scanners, Bluetooth™ devices, NFC (near field communication) devices, or other devices for detecting, scanning or otherwise communicating with tracking devices 110.

A server 120 can receive and store location information from tracking devices 110. In some examples, a server 120 responds to reporting devices 130 requesting stored location information.

In some examples, the server 120 can be a general purpose computer, a computer server, a mobile computer, a tablet, a mobile phone or any other suitable device. In some examples, the server 120 is also a reporting device 130 and/or a tracking device 110 associated with a mobile resource.

A reporting device 130 can request location information from a server 120 or tracking devices 110. A reporting device 130 can be a general purpose computer, a mobile phone, a tablet, a mobile computer, or any other suitable device. The reporting device can include or can be connected to a display or other means for displaying location information to a user. In some examples, there can be no standalone server 120; instead, a reporting device 130 can request location information directly from one or more tracking devices 110 before displaying information to a user. In some examples, the reporting device 130 can itself be a tracking device 110 associated with a mobile resource.

In some examples, as illustrated in FIG. 2, a reporting device 130 can be any device that can connect to a server 120 and/or to one or more tracking devices 110. For example, the reporting device 130 can be any device running an application or web browser that can connect to the server 120 or a tracking device 110 via the network 101.

In some examples, one or more of the tracking devices 110, servers 120, and reporting devices 130 can include processors, communication modules, storage media, and/or other components.

FIGS. 3 and 5 show flowchart of example methods 300 for tracking mobile resources.

For example, system 100 can be used to acquire 310 location information of one or more tracking devices 110, acquire 320 information regarding the length of time a tracking device has been at a location, and display 330 one or more visual location indicators in accordance with the length of time the tracking device has been at the location.

In some examples, location information can include GPS coordinates, information regarding wireless access points or communication devices to which a tracking device is connected, information regarding a detecting device to which a tracking device was most recently detected.

In some examples, the length of time can be based on a duration of time for which a tracking device is stationary or is within a defined distance to a particular position, location or centroid. In some examples, the length of time at a location can be based on a duration of time that a tracking device is connected to a wireless access point, or a duration of time between when a tracking device is detected by a first detecting device until the tracking device is detected by a second detecting device.

With reference to FIG. 5, system 100 can be used to determine 525 a length of time at a location. In some examples, this can include combining location and length of time information. For example, when a tracking device is at a first position and moves within a threshold distance of the first position (e.g. 20 meters), the tracking device can be determined to be located at the first position for the entire duration of time in which it is moving but stays within the predefined distance of the first position.

In another example, when a tracking device is initially at a first position and after defined period of time (e.g. 1 minute) has elapsed, the tracking device is at a second position within a threshold distance (e.g. 20 meters) of the first position, the location of the tracking device for this period of time can be determined to be a single location. Similarly, if after a second defined period of time has elapsed, the tracking device has moved from the second position to a third position within the threshold distance, the location of the tracking device for the entire period of time from when to the tracking device was at the first position until the time when the tracking device was at the third position can be determined to be a single location.

In some examples, when a tracking device stays within a threshold distance for a period of time, the location of the tracking device during this period can be determined to be a midpoint, an average position, or a weighted/centroid position based on the amount of time spent at various positions within the threshold distance.

In some examples, location information and lengths of time for one or more tracking devices can be compiled and stored at the tracking devices themselves, one or more servers, one or more reporting devices, or any combination thereof.

Visual location information can be displayed as a visual location indicator based on the length of time a tracking device has spent at one or more locations. In some examples, visual attributes of the displayed location indicator are based on the length of time spent at one or more locations.

In one example, the visual indicator can be displayed as a highlighted area on a map corresponding to the location information. In some examples, the longer the duration of time spent at a location, the larger the visual indicator. In some examples, the longer the duration of time spent at a location, the darker or more intense the highlighted area becomes.

For example, FIG. 4 illustrates an example display view 400 which can be displayed at a reporting device. A display view 400 can include a map 405 as illustrated in FIG. 4. In other examples, the display view 400 can include a building floor plan, a blueprint, a globe, or any other view providing geographic or relative location information.

In the example view in FIG. 4, a first example visual indicator 410a and a second example visual indicator 410b are displayed as highlighted circular areas. A first visual indicator 410a illustrated at location 2 has a larger radius and area than the second visual indicator 410b illustrated at location 1. In some examples, the size of a visual indicator can represent the time spent at a location. For example, visual indicators 410a and 410b can indicate that a tracking device spent more time at location 2 than at location 1.

While example visual indicators 410a and 420b are displayed as circles, visual indicators can be triangular, rectangular, irregular, or any other shape.

In some examples, visual indicators can be displayed as 3-dimensional bars which have lengths corresponding to the duration of time spent at the location. Different 3-dimensional shapes or objects can also be used to communicate the duration of time spent at a location.

In some examples, visual indicators can be displayed in different colors based on the length of time spent at a location. For example, a visual indicator can be displayed having a color between the spectrum of green to red depending on the length of time spent at the corresponding location.

In other examples, visual indicators can use any one or combination methods of 2-dimensional objects, 3-dimensional objects, color, shape or size, changes of shapes or any other visual indicator to indicate the length of time spent at the corresponding location.

Referring to the example display view 400 in FIG. 4, when a tracking device is in motion, overlapping visual indicators can appear as a path 410c.

In some examples, the method 300 can include filtering out some location information before visual location indicators are displayed. For example, to provide location information only for today, any location information from yesterday or before can be filtered such that it is not displayed as a visual indicator. In another example, a filter can also be applied to location information when a tracking device is moving over defined speeds or over defined distance thresholds in order to not display visual indicators for when a tracking device is moving to a different site.

In some examples, the amount of time spent at a location can be displayed at or proximate to the corresponding visual indicator. In some examples, a time of day (e.g. 10 am, 5 pm) at which the tracking device was at a location can be displayed at or proximate to the corresponding visual indicator.

As illustrated for example in FIG. 4, display view 400 can provide information on how long a mobile resource associated with a tracking device has spent at various locations. For example, a system 100 can be used to track remote personnel such as salespersons, insurance brokers, or tradespersons. System 100 can, in some examples, be used to track employees within a building such as doctors in a hospital, cleaning staff in a hotel or servers in a restaurant.

In an example application for tradespersons, a manager or head contractor could use a system 100 to provide visual information of where and how long an employee or sub-contractor spent at different locations based on the information provided by a tracking device associated with the employee or sub-contractor. In some examples, this can provide confirmation of hours spent working or travelling, or whether too much or too little time is spent at certain locations. In some examples, a display view 400 can provide information which can be used to assign tasks to different mobile resources in a more efficient manner.

System 100 can, in some examples, provide information on mobile resources other than personnel. For example, a display view can provide information on the travel patterns and waiting times of vehicles such as taxis, delivery or pickup vehicles, emergency vehicles and the like. In some examples, a display view can provide information on tools or equipment such as mobile payment terminals, wheelchairs, or trolleys.

The system and method 100 can, in some examples, be used within a small geographic area such as a building or on a single floor, within a larger geographic area such as a neighborhood or city, or within a large scale area such as a province or country.

The system and method 100 can in some cases track a single object with multiple tracking units in a single monitoring session. Two or more sessions may also be combined into a single session. The tracking of an object from the initiation of tracking to termination of tracking is considered a monitoring session. During a single monitoring session, a single location tracking device may be used or multiple location tracking devices associated with a single object can be used and the data saved by the server for processing by the reporting device. Separate sessions can be initiated for each device and later combined by the reporting device. Each of the location tracking devices can use the same or different location tracking or reporting methods, e.g. a one tracking device can be a GPS transmitter, while at the same time a cellular telephone is being used for tracking, upon entering a building, the GPS unit may lose signal while the cellular telephone continues to operate. Going further into the building, an RFID tag that is capable of being read by Wifi routes can take over or supplement the cellular telephone. Upon entering certain areas of the building may cause the cellular telephone to lose tracking as well while the RFID continues reporting location. It is possible to lose all three of these tracking devices, but at a later time reacquire any one, some or all of the tracking units but this would still be considered a single monitoring session. The interface for a reporting unit gives the user the option to separate this session into multiple sessions, e.g. showing only the RFID, the GPS receiver or the cellular telephone tracking information, or any combination of the tracking units associated with an object in a single session. It would be possible also to split it into just two sessions, the time before all signal was lost and another for when signal was reacquired, with or without an indication of how long tracking was lost.

The system and method 100 is especially useful in tracking personnel who travel from their normal place of work or personnel whose normal place of work changes frequently. Such personnel can include, for example, electricians, plumbers, and HVAC technicians who must go to alternative locations to render their services. These alternative locations can be different floors in a building or different buildings in a city or across the world depending on the technicians qualifications or duties. The system can track their location while they are on the clock to ensure that they are at their duty location or that they are not charging for time on site when they are physically not present. It can also be used to track delivery personnel, drivers such as a couriers, pizza delivery drivers, long haul truck drivers, and others whose job it is to travel between different locations. Monitoring routes personnel take can be used to aggregate data to determine which routes are best, which are slowest, and whether there are certain areas that should be avoided because of past issues in the area.

The location tracking device can be attached to a person, such as to their clothing in a uniform, or inside an item, such as a microchip or RFID tag inside a piece of equipment. It can be something that is carried by the individual, such as they keys to a vehicle while the vehicle also has another tracking unit such as one that uses the vehicles navigation system to report the location of the vehicle in conjunction to the location of the person and the tools the person is carrying with them. These can all be combined into a single monitoring session to indicate where each of these items is staying individually or they can be group together to indicate how long someone spent at a work site. The combination can be set to only report when the keys are moved a set distance away from the vehicles location and then tracking commences and only shows the location of the vehicle as a static point and shows the location of the keys are to the vehicle and tracks the keys normally.

The reporting device can be preprogrammed to take action based on certain events. For example, if tracking is reacquired within a certain area of a loss of signal, the sessions will be combined into a single sessions such that if a cellular telephone tracker is turned off at a hotel and turned back on the next day at the same hotel, the reporting device determines that the user stayed at that location for the period of time that there was no tracking. Alternatively, the system can be set, if two separate tracking sessions are combined, to allow the user to determine how to mark the time between the two sessions, be it as time spent at that location or simply no data received.

In addition, the instructions and/or data used in the practice of the invention may utilize any compression or encryption technique or algorithm, as may be desired. An encryption module might be used to encrypt data or the communications pathways used by the data. Further, files or other data may be decrypted using a suitable decryption module.

The processing unit that executes commands and instructions may be a general purpose computer, but may utilize any of a wide variety of other technologies including a special purpose computer, a microcomputer, mini-computer, mainframe computer, processor, CPU (Central Processing Unit), programmed micro-processor, micro-controller, peripheral integrated circuit element, a CSIC (Visitor Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

Location data includes at a minimum the location of the device. This can be expressed in any standard coordinate system such as by latitude and longitude with or without elevation, MGRS coordinates, Cartesian coordinates etc. Location data also can be expressed as relative data, such as X meters from a known location such as the position of a cellular telephone tower, or relative data such as the location tracking device has moved Y miles at an angle of Θ degrees from the its previous location or relative to receiver, reader or other known location point.

Generally, it should be noted that the components depicted and described herein above may be, or include, a computer or multiple computers. Although the components are shown as discrete units, all components may be interconnected or combined. The components may be described in the general context of computer-executable instructions, such as program modules, being executed by a computer. Generally, program modules include routines, programs, objects, applications, components, data structures, etc., that perform particular tasks or implement particular abstract data types.

Those skilled in the art will appreciate that the invention may be practiced with various computer system configurations, including hand-held wireless devices such as mobile phones, tablets or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The processing unit that executes commands and instructions may be a general purpose computer, but may utilize any of a wide variety of other technologies including a special purpose computer, a microcomputer, mini-computer, mainframe computer, processor, CPU (Central Processing Unit), programmed micro-processor, micro-controller, peripheral integrated circuit element, a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It is appreciated that in order to practice the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

A user interface may include any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

Although many other internal components of the computer are not shown, those of ordinary skill in the art will appreciate that such components and the interconnections are well known. Accordingly, additional details concerning the internal construction of the computer need not be disclosed in connection with the present invention.

The various embodiments and features of the presently disclosed invention may be used in any combination, as the combination of these embodiments and features are well within the scope of the invention. While the foregoing description includes many details and specificities, it is to be understood that these have been included for purposes of explanation only, and are not to be interpreted as limitations of the present invention. It will be apparent to those skilled in the art that other modifications to the embodiments described above can be made without departing from the spirit and scope of the invention. Accordingly, such modifications are considered within the scope of the invention as intended to be encompassed by the following claims and their legal equivalents.

What is claimed:

1. A location monitoring system which comprises:
a server for receiving location data from one or more location tracking devices during a monitoring session and storing the location data;
a display unit for displaying a graphical display and a map; and
a reporting device for generating the graphical display, whereby the reporting device utilizes at least one computer processor executing software code to perform steps including:
receiving location data from the server or from the one or more location tracking devices;
creating monitoring session data by calculating lengths of time associated with location(s) indicated by the location data;
generating, on the basis of the monitoring session data, the graphical display that overlays on a map, wherein the graphical display presents a visual indicator that identifies location(s) and amount(s) of time spent at the location(s); and
communicating the graphical display to the display unit.

2. The system of claim 1, wherein said reporting device communicates said graphical display to said display unit in near-real-time during the monitoring session.

3. The system in claim 1, wherein the reporting device and the server are integrated into a single unit.

4. The system in claim 1, wherein the visual indicator comprises a two-dimensional or three-dimensional location symbol for each identified location.

5. The system in claim 1, wherein the reporting device uses location tracking data from more than one sensor, where the sensors are one or more different types, to create a single monitoring session display graphic.

6. The system of claim 4, wherein the location symbol utilizes variation in one or more of color, shape and size to indicate the amount(s) of time spent at the identified location(s).

7. A computer-implemented method for visually displaying the amount of time spent at one or more locations, the method comprising:
receiving location data at a server from one or more location tracking devices during a monitoring session and storing the location data;
communicating the location data from the server to a reporting device that comprises at least one processor;
creating, using the at least one processor at the reporting device, monitoring session data by calculating one or more lengths of time associated with location(s) indicated by the location data;
generating, using the at least one processor at the reporting device, on the basis of the monitoring session data, a graphical display that overlays on a map, wherein the graphical display presents a visual indicator that identifies location(s) and amount(s) of time spent at the location(s);
communicating the graphical display from the reporting device to a display unit; and
displaying the graphical display and the map at the display unit.

8. The computer-implemented method of claim 6, wherein the step of communicating the graphical display from the reporting device to a display unit and the step of displaying the graphical display and the map at the display unit occur in near-real-time during the monitoring session.

9. The computer-implemented method of claim 6, wherein the reporting device and the server are integrated into a single unit and the step of receiving the location data at the server is controlled by the at least one processor at the reporting device.

10. The computer-implemented method of claim 6, wherein the at least one processor controlling the reporting device uses location tracking data from more than one sensor, where the sensors are from one or more sensor types, to create a single monitoring session display graphic.

11. The computer-implemented method of claim 6, wherein the visual indicator comprises a two-dimensional or three-dimensional location symbol for each identified location.

12. The computer-implemented method of claim 11, wherein the location symbol utilizes variation in one or more of color, shape and size to indicate the amount(s) of time spent at the identified location.
